(19) United States
(12) Patent Application Publication
(10) Pub. No.: US 2016/0177824 A1
(43) Pub. Date: Jun. 23, 2016

(54) GAS TURBINE ENGINE INTAKE DUCT

(71) Applicant: ROLLS-ROYCE plc, London (GB)

(72) Inventors: Anthony John Charles PONTON, Bristol (GB); Gordon David WARNES, Portishead (GB)

(73) Assignee: ROLLS-ROYCE plc, London (GB)

(21) Appl. No.: 14/950,804

(22) Filed: Nov. 24, 2015

(30) Foreign Application Priority Data
Dec. 22, 2014 (GB) 1422948.8

(51) Int. Cl. F02C 7/052

(52) U.S. Cl. CPC F02C 7/052

(57) ABSTRACT

A gas turbine engine intake duct 30, 80, 100 having an internal duct surface 54 comprising a main region 60, 82 having a particular finish and a secondary region 62, 84, 102 having a different finish.

To be accompanied when published by FIG. 2.

The present disclosure concerns gas turbine engines. More specifically the disclosure concerns a gas turbine engine intake duct, a method of altering the direction in which debris particles (such as sand, birds, rain, hail, ice and other foreign objects) will bounce or deflect from a particular region of an internal duct surface of a gas turbine engine intake duct and a method of designing a gas turbine engine.

The disclosure may be particularly relevant to gas turbine engines typically used in conditions where a relatively high number of particles might be expected to be ingested into the engine intake (examples include helicopters and fighting vehicles e.g. tanks). Nonetheless this is not intended to be limiting and the disclosure may have application to gas turbines used in many alternative applications (e.g. aeroplane engines, marine engines and land based power plant gas turbines).

The ingestion of debris particles in to gas turbine engines is a well-known problem. Ingested debris particles that reach the core of the gas turbine engine can cause erosion and/or corrosion of core components and/or coat them. Another particular problem is the build-up of debris particles in and around cooling holes in blades and vanes. The holes often have relatively small diameters and are easily blocked. If cooling holes are blocked, cooling of the blade or vane may be inadequate, potentially leading to blade/vane overheating and corrosion.

One way to address these problems is to attempt to prevent the ingestion of debris particles into the engine core. Many existing systems attempt to control the path of debris particles as they travel through an intake duct in a manner such that they may be separated from a core gas flow that continues to the core. A known method of achieving this is the use of an intake duct having a convoluted shape. The mass of debris particles travelling in the air stream tends to mean that they are forced radially outwards as the air stream follows the turn of the convolution. In this way they may enter a scavenge duct formed by a bifurcation in the intake duct.

If the convolution is suitably shaped and an inlet to the scavenge duct is suitably located, it may also capture heavier debris particles that follow a substantially ballistic path, the heavier particles bouncing in a relatively predictable manner where they hit internal surfaces of the intake duct. Attempting to additionally separate heavier particles in this way may however introduce a compromise. Specifically the degree of curvature of the convoluted path may need to be increased in order to prevent or reduce the bouncing of heavier particles such that they bypass the scavenge duct and enter a core duct of the intake duct. An increase in the curvature of the convolution may however increase flow separation occurring at the bifurcation, potentially giving rise to a flow separation bubble capable of trapping debris particles. The trapped debris particles may be prevented from entering the scavenge duct and may ultimately be ingested into the core of the gas turbine engine.

According to a first aspect of the invention there is provided a gas turbine engine intake duct optionally having an internal duct surface comprising optionally a main region optionally having a particular finish and optionally a secondary region optionally having a different finish. The provision of regions having different finishes may allow greater control over debris particle path and/or break-up of debris particles in the intake duct.

In some embodiments the internal duct surface bounds the intake duct in a radial sense. Thus the internal duct surface may be formed by ducting itself, rather than, for instance aerofoils or other features which might span or otherwise project away from the internal duct surface.

In some embodiments the different finish of the secondary region is arranged to alter the direction in which debris particles will bounce from that surface by comparison with particle bounce directions that would occur if the second region had the same finish as the main region.

In some embodiments the main region and secondary region comprise materials having different coefficients of restitution. Where the or a difference in the surface finishes constitutes a difference in the coefficient of restitution, the angle at which an incident debris particle will bounce/deflect at that region may be different. Surfaces with a lower coefficient of restitution, (e.g. softer surfaces) will absorb more incident energy. In a bounce event, the tangential component of velocity is largely maintained regardless of the coefficient of restitution of the surface, but the normal component is factored by the coefficient of restitution. Therefore bounces at softer surfaces are shallower. It is further noted that an overall reduction in energy resulting from a bounce at a softer surface may mean that the trajectory of a debris particle is impacted more by other forces (e.g. gravity and/or forces created by a fluid flow through the intake duct). This may mean that a debris particle following a substantially ballistic path prior to a bounce event, no longer follows a substantially ballistic path following the event.

In some embodiments the secondary region has a lower coefficient of restitution than the main region. The main region may for example comprise a metal finish, while the secondary region may for example comprise an elastomer or rubber finish.

In some embodiments the main region is substantially smooth and the secondary region comprises variations in surface profile. The secondary region may for example comprise raised and/or lowered surface features. The surface features may for instance comprise grooves, ribs or dimples. As will be appreciated, such surface features may be used to influence the trajectory of a particle bouncing at or impacting the surface. By way of example, parabolic dimples might focus particles along a path, while sloped surfaces may consistently widen or narrow particle bounce angles. Multi-faceted surfaces might also be used to randomise trajectories after impact. Sharp features might be used to break up particles such as hail and ice, while channels may be used to direct material after impact, e.g. the flow direction of water droplets.

In some embodiments the secondary region is located to encompass an intersection with the internal duct surface of a substantially ballistic path travelled by a debris particle, the debris particle entering an inlet to the intake duct on a path parallel to a conventional fluid stream direction that would enter the inlet in use of the gas turbine engine. This may be advantageous where it is desirable to target particles travelling on substantially ballistic trajectories, modifying the angle of their bounce at the internal duct surface by comparison with the angle that would otherwise result.

In some embodiments the substantially ballistic path incorporates at least one previous intersection with the internal duct surface and bounce therefrom.

In some embodiments there are provided one or more additional secondary regions.

In some embodiments the intake duct comprises an inlet duct which bifurcates into a core duct and a scavenge duct.

In some embodiments the one or more secondary regions are arranged so that for debris particles following a ballistic path and colliding with the one or more secondary regions, the proportion that enter the scavenge duct is increased. As will be appreciated the secondary regions may alter the angle at which debris particles will bounce after impacting the internal duct surface in a predictable manner. Particles may therefore be directed into the scavenge duct.

In some embodiments the intake duct follows a convoluted path so as there is no clear line of sight through the intake duct along a ballistic trajectory. In this way the intake duct may be arranged to encourage one or more impacts of particles above a particular mass that will follow substantially ballistic trajectories. Such impacts may provide one means by which the internal duct surfaces can be used to reliably influence particle trajectories.

In some embodiments at least part of the intake duct follows a substantially ‘U’ shaped path, with the bifurcation located substantially at a transition between a turn and return branch of the ‘U’ shaped path. Arrangements such as this may be designed to separate both lighter particles (tending to follow the fluid stream) and heavier particles (tending to follow ballistic paths) from a fluidflow intended for a core of the gas turbine engine. The velocity of the lighter particles is increased by the convolution and optional contraction in the flow path to an extent that their momentum forces exceed aerodynamic forces and their inertia tends to carry them into the scavenge duct. The trajectories of heavier particles are less influenced by aerodynamic forces and they tend to bounce on the internal duct surfaces and into the scavenge duct. By providing the one or more secondary regions in order to influence the bounce angle of impacting particles, it may be possible to shallow the convolution (reduce the severity of the turn i.e. increase its radius of curvature), while still capturing the heavier particles. A shallower convolution may reduce flow separation occurring at the bifurcation, which otherwise might give rise to a flow separation bubble capable of trapping debris particles, preventing their entry into the scavenge duct and allowing their ingestion into the core duct.

In some embodiments a secondary region is provided at a first impact area corresponding to a portion of the internal duct surface substantially opposed to its inlet. This may mean that debris particles following a substantially ballistic path have their bounce angles altered by the secondary region at their first interaction with the internal duct surface.

In some embodiments a secondary region is provided at a second impact area corresponding to a portion of the intake duct on which debris particles are incident following a first impact with the internal duct surface of the intake duct. The second impact area may be on the opposite radial side of the internal duct surface to the first impact area and may be located substantially at a transition between a departing branch of the ‘U’ shaped path and its turn. As will be appreciated the first impact area may or may not comprise a secondary region.

In some embodiments the different finish of the secondary region is arranged to increase the size of the bounce angle at which debris particles will bounce from that surface by comparison with particle bounce directions that would occur if the second region had the same finish as the main region. This arrangement, especially where used at a second impact area, may allow a shallowing of the convolution without causing debris particles following a ballistic trajectory from being deflected away from the scavenge duct.

In some embodiments the secondary region comprises a layer of material provided on an underlying duct wall. This may be a convenient method of providing the secondary region, which may also allow retrofitting to existing engines.

As will be appreciated various shapes and configurations of inlet duct, scavenge duct and core duct are possible. By way of example one, some or all of the ducts may have an annular cross-section, or alternatively one, some or all may have a circular, square, rectangular or alternatively shaped cross-section. Further a combination of these cross-sectional shapes is possible, e.g. an annular inlet duct and scavenge duct and a circular core duct, or a rectangular intake and scavenge duct and a circular core duct. Further still the cross-sectional shape of any of the ducts may alter along its extent. The core duct may for example have an annular cross-section at an upstream location and a circular cross-section at a downstream location.

According to a second aspect of the invention there is provided a method of altering the direction in which debris particles will bounce or deflect from a particular region of an internal duct surface of gas turbine engine intake duct, comprising applying a material to the region of the surface to create a secondary region having a different finish to a pre-existing main region of the surface.

According to a third aspect of the invention there is provided a method of designing a gas turbine engine comprising a convoluted intake duct and a particle scavenge duct, the convoluted intake duct being arranged to direct debris particles into the scavenge duct, the method comprising the steps of:
utilising in the design a secondary region of an internal duct surface comprising a different finish to a main region of the internal duct surface to alter the direction in which debris particles will bounce or deflect from that surface by comparison with particle bounce or deflection directions that would occur if the second region had the same finish as the main region, in order that the degree of convolution required to direct particles bouncing or deflecting on that surface into the scavenge duct is altered; and
altering the degree of convolution in the intake duct design accordingly.

The skilled person will appreciate that except where mutually exclusive, a feature described in relation to any one of the above aspects of the invention may be applied mutatis mutandis to any other aspect of the invention.

Embodiments of the invention will now be described by way of example only, with reference to the Figures, in which:

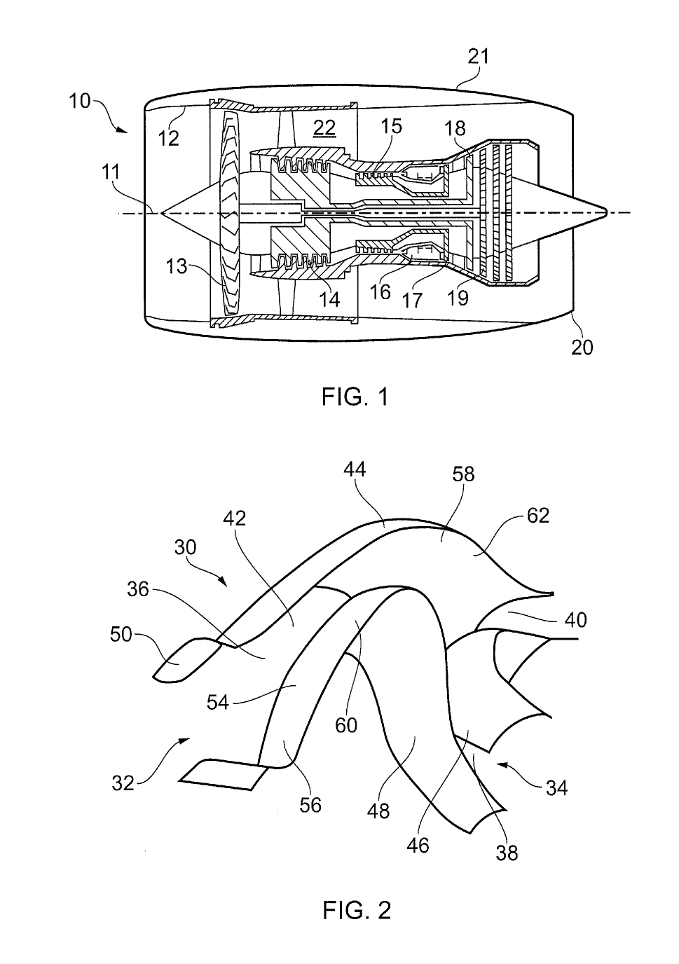

FIG. 1 is a sectional side view of a gas turbine engine;

FIG. 2 is a schematic perspective view of a gas turbine engine intake duct according to an embodiment of the invention;

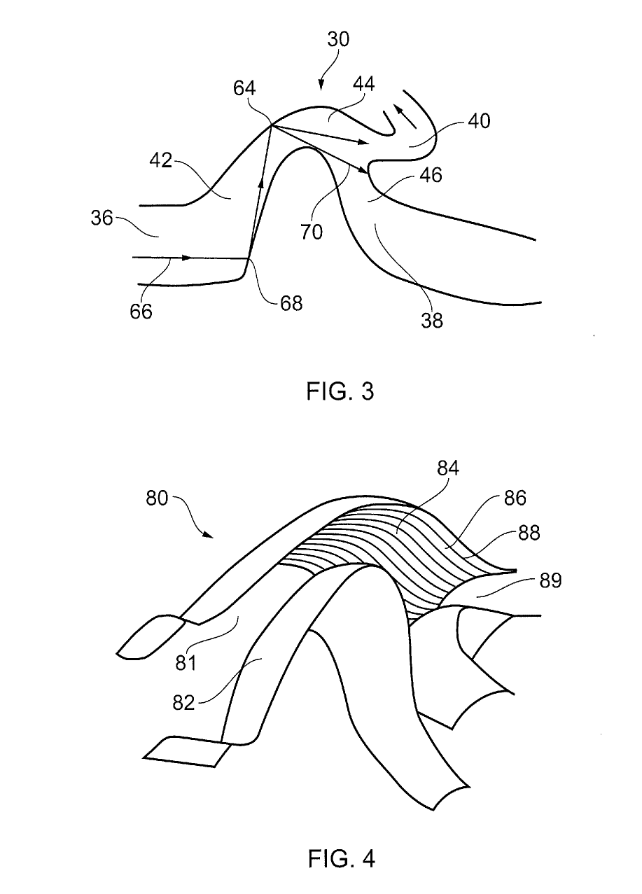

FIG. 3 is a schematic cross sectional view of gas turbine engine intake duct according to an embodiment of the invention;

FIG. 4 is a schematic perspective view of a gas turbine engine intake duct according to an embodiment of the invention;

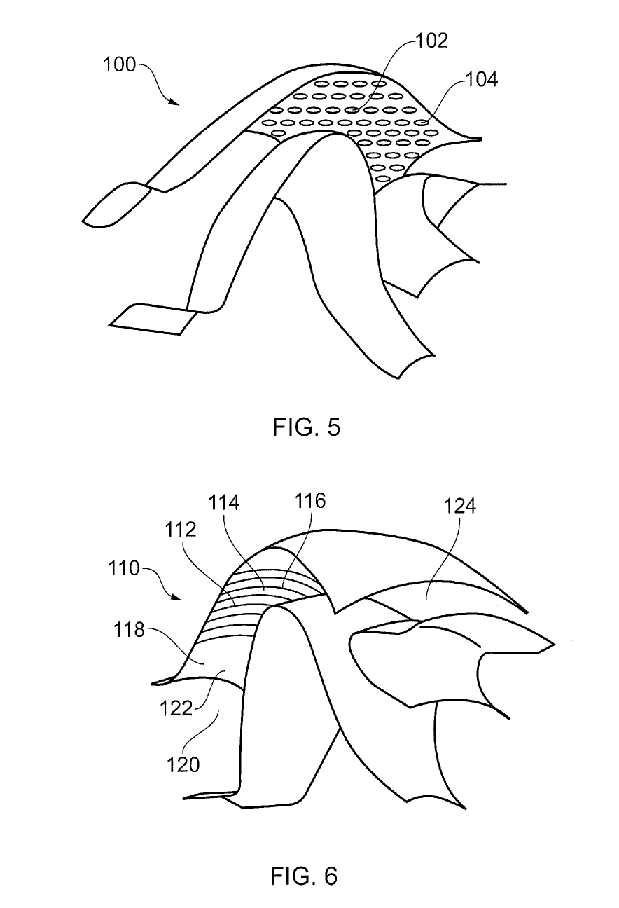

FIG. 5 is a schematic perspective view of a gas turbine engine intake duct according to an embodiment of the invention;

FIG. 6 is a schematic perspective view of a gas turbine engine intake duct according to an embodiment of the invention.

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Referring now to FIGS. 2 and 3 a gas turbine engine intake duct is generally provided at 30. The intake duct 30 defines a fluid flowpath and is forward of the core engine components of an associated gas turbine engine (not shown). The intake duct 30 follows a convoluted, substantially ‘U’ shaped path, from an upstream location 32 to a downstream location 34. The intake duct 30 comprises an inlet duct 36 which bifurcates into a core duct 38 and a scavenge duct 40. The core duct 38 feeds a core (not shown) of an associated gas turbine engine. The ‘U’ shape of the convoluted path may be considered to have a departing branch 42, a turn 44 and a return branch 46. The bifurcation is located at a transition between the turn 44 and return branch 46.

Although for clarity only portions of walls of the duct 30 are shown, it will be appreciated that that each is part of an annular wall, the annular walls defining the various ducts 36, 38, 40.

The inlet duct 36 has an internal duct surface 54 including a radially inner surface 56 and a radially outer surface 58. The internal duct surface 54 has a main region 60 having a particular finish (in this case metallic). The internal duct surface 54 also has a secondary region 62 having a different finish (in this case rubber) to the main region 60. The main region 60 encompasses substantially all of the internal duct surface 54 with the exception of the secondary region 62.

The secondary region 62 is provided on the radially outer surface 58 of the internal duct surface 54, in the region of the turn 44 and an interface between the departing branch 42 and turn 44. The area covered by the secondary region 62 may be considered a second impact area of the internal duct surface 54. This area encompasses a second intersection 64 with the internal duct surface 54 of a substantially ballistic path 66 travelled by a debris particle entering an inlet of the intake duct 30 in a direction corresponding to a conventional fluid stream direction into the inlet. The ballistic path 66 further incorporates a first intersection 68 with the internal duct surface 54 at which the debris particle bounces. The first intersection 68 occurs in an area of the radially inner surface 56 that may be considered a first impact area and which is substantially opposed to the inlet. Following a second bounce at the second intersection 64 the ballistic path 66 takes the particle into the scavenge duct 40.

Because the rubber finish of the secondary region 62 has a lower coefficient of restitution than the metallic finish of the main region 60, the bounce angle occurring at the second intersection 64 will be wider than it otherwise would have been. This means that the convolution in the intake duct 30 can be shallower than would otherwise be necessary for the ballistic path 66 to pass into the scavenge duct 40. For comparison, an alternative and imaginary continuation 70 of the ballistic path following the second intersection 64 is shown, assuming the secondary region 62 had the same surface finish as the main region 60. As can be seen the continuation 70 leads to the core duct 38.

Reducing the degree of curvature of the convolution may be advantageous as it may reduce the rate of at which a scavenge flow diffuses into the scavenge duct 40. This may in turn reduce the extent and/or prevent the formation of a flow separation bubble, which might otherwise trap debris particles and ultimately allow them to be ingested into the core duct 38

As will be appreciated, the embodiment of FIGS. 2 and 3 may also be used to separate lighter debris particles tending to follow non-ballistic paths, substantially entrained instead with the flow of fluid through the intake duct 30. Such particles tend to have their velocities increased by the convolution in the flow path to an extent that they cannot ‘make the turn’ and their inertia tends to carry them into the scavenge duct 40, it being radially outward of the core duct 38.

As will be appreciated, and although not shown in the Figures, in other embodiments one or more additional secondary regions may be provided. It may be for example that an additional secondary region is provided throughout the first impact area previously described. In this case it may be that the additional secondary region is desirable for directing debris particles following a ballistic trajectory towards the second impact area as previously described. In any case, the use of multiple secondary regions may allow adjustment to the ballistic trajectory to be made cumulatively. This may facilitate the use of alternative convolution geometries that would otherwise perform unsatisfactorily in terms of debris particle separation.

Referring now to FIG. 4 an alternative gas turbine engine intake duct embodiment is generally provided at 80. The gas turbine engine intake duct 80 is the same as the intake duct 30 with the exception of the nature of the secondary region. Rather than an inlet duct 81 comprising a finish having a different coefficient of restitution to a main region 82, a secondary region 84 of the inlet duct 81 comprises variations in surface profile. These variations in surface profile contrast with the substantially smooth main region 82. The variations in surface profile of the secondary region 84 are provided by a series of raised and lowered surface features in the form of alternating grooves 86 and ribs 88 extending in the axial direction. The grooves 86 and ribs 88 may alter trajectory at which debris particles deflect from the secondary region 84. Specifically the ribs 88 may break up some particles such as ice, while the grooves 86 may direct water droplets into a scavenge duct 89.

Referring now to FIG. 5 an alternative gas turbine engine intake duct embodiment is generally provided at 100. The gas turbine engine intake duct 100 is the same as the intake duct 80 with the exception of the nature of the secondary region. Rather than comprising a finish having alternating grooves 86 and ribs 88, a secondary region 102 of the intake duct 100 comprises lowered surface features in the form of a plurality of dimples 104. The dimples 104 may have the effect of focussing the resultant trajectories of debris particles incident into the dimples occurring after bounce events of the particles with the secondary region 102.

Referring now to FIG. 6 an alternative gas turbine engine intake duct embodiment is generally provided at 110. The gas turbine engine intake duct 110 is the same as the intake duct 80 with the exception of the nature and positioning of the secondary region. Rather than comprising a finish having axial orientated grooves and ribs, a secondary region 112 of the intake duct 110 comprises alternating grooves 114 and ribs 116 extending in the circumferential direction. Further the secondary region 112 is provided on a radially outer surface 118 of an inlet duct 120 of the intake duct 110 in the region a departing branch 122 of the convolution. The grooves 114 may re-direct particles impacting the secondary region 112 towards a scavenge duct 124, in particular particles impacting the secondary region at a shallow angle and/or relatively small aerodynamically driven particles.

As will be appreciated the exemplary surface finishes described above are non-limiting examples only. Further that different or similar secondary surface finishes having different locations may be combined in a single intake duct. When combined, the secondary surfaces may work in a complimentary manner, e.g. one surface directing particles at another or different surfaces targeting particles of different masses and/or compositions.

It will be understood that the invention is not limited to the embodiments above-described and various modifications and improvements can be made without departing from the various concepts described herein. By way of example, in some embodiments one or more of the secondary regions might be arranged to wear in a predictable manner with a view to modifying bounce trajectories over time. Further one or more secondary regions might be provided with an anti-accretion (e.g. hydrophobic) coating and/or a RADAR absorbing surface treatment. Except where mutually exclusive, any of the features may be employed separately or in combination with any other features and the invention extends to and includes all combinations and sub-combinations of one or more features described herein in any form of gas turbine engine intake duct.

1. A gas turbine engine intake duct having an internal duct surface comprising a main region having a particular finish and a secondary region having a different finish.

2. A gas turbine engine intake duct according to claim 1 where the different finish of the secondary region is arranged to alter the direction in which debris particles will bounce from that surface by comparison with particle bounce directions that would occur if the second region had the same finish as the main region.

3. A gas turbine engine intake duct according to claim 1 where the main region and secondary region comprise materials having different coefficients of restitution.

4. A gas turbine engine intake duct according to claim 3 where the secondary region has a lower coefficient of restitution than the main region.

5. A gas turbine engine intake duct according to claim 1 where the main region is substantially smooth and the secondary region comprises variations in surface profile.

6. A gas turbine engine intake duct according to claim 1 where the secondary region is located to encompass an intersection with the internal duct surface of a substantially ballistic path travelled by a debris particle, the debris particle entering an inlet to the intake duct on a path parallel to a conventional fluid stream direction that would enter the inlet in use of the gas turbine engine.

7. A gas turbine engine intake duct according to claim 6 where the substantially ballistic path incorporates at least one previous intersection with the internal duct surface and bounce therefrom.

8. A gas turbine engine intake duct according to claim 1 where there are provided one or more additional secondary regions.

9. A gas turbine engine intake duct according to claim 1 where the intake duct comprises an inlet duct which bifurcates into a core duct and a scavenge duct.

10. A gas turbine engine intake duct according to claim 9 where the intake duct follows a convoluted path so as there is no clear line of sight through the intake duct along a ballistic trajectory.

11. A gas turbine engine intake duct according to claim 10 where at least part of the intake duct follows a substantially ‘U’ shaped path, with the bifurcation located substantially at a transition between a turn and return branch of the ‘U’ shaped path.

12. A gas turbine engine intake duct according to claim 1 where a secondary region is provided at a second impact area corresponding to a portion of the intake duct on which debris particles are incident following a first impact with the internal duct surface of the intake duct.

13. A gas turbine engine intake duct according to claim 1 where the different finish of the secondary region is arranged to increase the size of the bounce angle at which debris particles will bounce from that surface by comparison with particle bounce directions that would occur if the second region had the same finish as the main region.

14. A method of altering the direction in which debris particles will bounce or deflect from a particular region of an internal duct surface of gas turbine engine intake duct, comprising applying a material to the region of the surface to create a secondary region having a different finish to a pre-existing main region of the surface.

15. A method of designing a gas turbine engine comprising a convoluted intake duct and a particle scavenge duct, the convoluted intake duct being arranged to direct debris particles into the scavenge duct, the method comprising the steps of:
utilising in the design a secondary region of an internal duct surface comprising a different finish to a main region of the internal duct surface to alter the direction in which debris particles will bounce or deflect from that surface by comparison with particle bounce or deflection directions that would occur if the second region had the same finish as the main region, in order that the degree of convolution required to direct particles bouncing or deflecting on that surface into the scavenge duct is altered; and
altering the degree of convolution in the intake duct design accordingly.
